(19) United States
(12) Patent Application Publication
(10) Pub. No.: US 2023/0274749 A1
(43) Pub. Date: Aug. 31, 2023

(54) Apparatus and Method for Audio Signal Transformation

(71) Applicant: Fraunhofer-Gesellschaft zur Foerderung der angewandten Forschung e.V., Munich (DE)

(72) Inventors: Nils PETERS, Erlangen (DE); Juergen HERRE, Erlangen (DE)

(21) Appl. No.: 18/311,096

(22) Filed: May 2, 2023

Related U.S. Application Data
(63) Continuation of application No. PCT/EP2021/080059, filed on Oct. 28, 2021.

(30) Foreign Application Priority Data
Nov. 3, 2020 (EP) 20205520.8

(51) Int. Cl. G10L 19/02

(52) U.S. Cl. CPC G10L 19/0212

(57) ABSTRACT

An apparatus for audio signal transformation is provided. The apparatus includes a determination unit configured for determining, using spherical harmonics information, a transformation rule for transforming an audio input signal within a first domain, being different from a spherical harmonics domain. Moreover, the apparatus includes a transformation unit configured for transforming, using the transformation rule, the audio input signal, being represented in the first domain, to obtain a transformed audio signal being represented in the first domain. The spherical harmonics information includes information on a plurality of spherical harmonics and/or includes information being represented in the spherical harmonics domain.

### CROSS-REFERENCES TO RELATED APPLICATIONS

This application is a continuation of copending International Application No. PCT/EP2021/080059, filed Oct. 28, 2021, which is incorporated herein by reference in its entirety, and additionally claims priority from European Application No. EP 20 205 520.8, filed Nov. 3, 2020, which is incorporated herein by reference in its entirety.

The present invention relates to an apparatus and method for audio signal transformation, for example, to an audio signal transformation within the equivalent spatial domain, and, in particular.

### BACKGROUND OF THE INVENTION

Sound radiated in a reverberant room interacts with objects and surfaces in the environment to create reflections. By using a spherical microphone array, it is possible to measure those reflections at a fixed point in the room and to visualize the incoming wave directions. The reflections arriving at the microphone array will cause a sound pressure distribution over the microphone sphere.

Such a sound field may first be transformed into the spherical harmonics domain. (SH domain). Figuratively, a combination of spatial shapes (see FIG. 6 below) is found, which describes the given sound pressure distribution on the sphere. The wave field decomposition, that is comparable to spatial filtering or beamforming, can be then executed in that domain to concentrate the shapes to the incident wave directions.

In order to define the spherical harmonics across the elevation angle β, a set of orthogonal functions may, e.g., be employed. The Legendre polynomials are orthogonal on the interval [−1, 1]. The first six polynomials are provided in the following:

P₀(x)=1

P₁(x)=x

P₂(x)=½(3x²−1)

P₃(x)=½(5x³−3x)

P₄(x)=⅛(35x⁴−30x²+3)

P₅(x)=⅛(63x⁵−70x³+15x)

The corresponding plots are shown in FIG. 5, wherein FIG. 5 illustrates Legendre polynomials up to the order n=5.

The elevation angle is defined between [0, π]. Therefore all orthogonal relations has to be transferred to the unit sphere. The associated Legendre polynomials Lₙ(cos β) can be used as follows:

∫₀^{π}f(cos β)sin βdβ=∫₋₁¹f(x)dx

Considering a sound pressure function P(r, β, α, k) in the spherical coordinate system, where β and α are the elevation and azimuth angles, r the radius and k the wavenumber (k=ω/c). Assuming that P(r, β, α, k) is square integrable over both angles, it can be represented in the spherical harmonics domain.

As can be seen below, the spherical harmonics are composed of the associated Legendre polynomials Lₙ^{m}, an exponential term e^{+jmα} and a normalization term. The Legendre polynomials are responsible for the shape across the elevation angle β and the exponential term is responsible for the azimuthal shape.

$${Y}_{n}^{m} ( β , α ) = \sqrt{\frac{2 n + 1}{4 π} \frac{( n - m ) !}{( n + m ) !}} {L}_{n}^{m} ( cos β ) {e}^{+ jm α}$$

FIG. 6 shows the spherical harmonics up to order n=4 and the corresponding modes, from −m to m. Each order consists of 2m+1 modes. The signs of the spherical harmonics are either positive 601 or negative 602.

The spherical harmonics are a complete and orthonormal set of Eigenfunctions of the angular component of the Laplace operator on a sphere, which is used to describe a wave equation.

The equivalent spatial domain (ESD) is a three dimensional spatial representation of Ambisonics audio signals. The ESD representation is based on the equidistant sampling of a sphere (see [2]) and consist of (N+1)² sampling directions θ with N being the Ambisonics order.

According to the 3GPP specification (see [1], chapter 4.1.1.2), an equivalent spatial domain representation of an N^{th} order Ambisonics soundfield representation can be obtained by rendering the Ambisonics soundfield representation to K virtual loudspeaker signals, (i.e., by converting the Ambisonics soundfield from the spherical harmonics domain into the equivalent spatial domain), wherein the respective K virtual loudspeaker positions are located on a unit sphere and may be expressed using a spherical coordinate system. The conversion rules for converting the Ambisonics soundfield from the spherical harmonics domain (Ambisonics Domain) into the equivalent spatial domain, and vice versa, are also provided in chapter 4.1.1.2 of [1]).

The ESD representation is defined and used, for example, as the signal domain for the MPEG-H decoder export interface for the Higher-Order Ambisonics content type (see [3], Clause 17.10.) as well as in the 3GPP specification (see [1]).

Spatial transformations in the spherical harmonics domain have been provided in the conventional technology, see, for example, Kronlachner, [4]. In Chapter 3 of Kronlachner, transformations of Ambisonics Recordings in the spherical harmonics domain are provided. For example, chapter 3.1 and chapter 3.2. There, e.g., weighting by a direction-dependent gain, applying an angular transformation and rotation in has been extensively described. As an example for a rotation around the z-Axis (yaw-rotation), Kronlachner provides in its equation 3.12 a spherical harmonic rotation matrix (i.e., a transformation matrix in the spherical harmonics domain). A plurality of other transformation examples in the spherical harmonics domain are also provided in the other subchapters 3.3 (directional loudness modifications), 3.4 (warping), 3.5 and 3.6 of chapter 3 of Kronlachner [4].

However, transformations of audio signals within particular domains, for example, within the equivalent spatial domain, have not been provided before.

The object of the present invention is to provide improved concepts for soundfield transformation.

### SUMMARY

An embodiment may have an apparatus for audio signal transformation, comprising: a determination unit configured for determining, using spherical harmonics information, a transformation rule for transforming an audio input signal within a first domain, being different from a spherical harmonics domain, and a transformation unit configured for transforming, using the transformation rule, the audio input signal, being represented in the first domain, to acquire a transformed audio signal being represented in the first domain, wherein the spherical harmonics information comprises information on a plurality of spherical harmonics and/or comprises information being represented in the spherical harmonics domain.

Another embodiment may have an apparatus for audio signal transformation, comprising: a first conversion unit configured for converting an audio input signal from a first domain into a spherical harmonics domain, wherein the first domain is different from the spherical harmonics domain, a transformation unit configured for transforming the audio input signal, being represented in the spherical harmonics domain, depending on a transformation rule within the spherical harmonics domain to acquire a transformed audio signal, being represented in the spherical harmonics domain, and a second conversion unit for converting the transformed audio signal from the spherical harmonics domain into the first domain.

Another embodiment may have an apparatus for audio signal transformation, comprising: a first conversion unit configured for converting an audio input signal from a first domain into an equivalent spatial domain, wherein the first domain is different from the equivalent spatial domain, a transformation unit configured for transforming the audio input signal, being represented in the equivalent spatial domain, depending on a transformation rule within the equivalent spatial domain to acquire a transformed audio signal, being represented in the equivalent spatial domain, and a second conversion unit for converting the transformed audio signal from the equivalent spatial domain into the first domain.

Another embodiment may have a decoder for decoding an encoded audio signal, wherein the decoder comprises: a decoding unit for decoding the encoded audio signal to acquire an audio input signal being represented in a first domain, and an apparatus for audio signal transformation, comprising: a determination unit configured for determining, using spherical harmonics information, a transformation rule for transforming an audio input signal within a first domain, being different from a spherical harmonics domain, and a transformation unit configured for transforming, using the transformation rule, the audio input signal, being represented in the first domain, to acquire a transformed audio signal being represented in the first domain, wherein the spherical harmonics information comprises information on a plurality of spherical harmonics and/or comprises information being represented in the spherical harmonics domain, for transforming the audio input signal to acquire a transformed audio signal, being represented in the first domain.

Another embodiment may have a decoder for decoding an encoded audio signal, wherein the decoder comprises: a decoding unit for decoding the encoded audio signal to acquire an audio input signal being represented in a first domain, and an apparatus for audio signal transformation, comprising: a first conversion unit configured for converting an audio input signal from a first domain into a spherical harmonics domain, wherein the first domain is different from the spherical harmonics domain, a transformation unit configured for transforming the audio input signal, being represented in the spherical harmonics domain, depending on a transformation rule within the spherical harmonics domain to acquire a transformed audio signal, being represented in the spherical harmonics domain, and a second conversion unit for converting the transformed audio signal from the spherical harmonics domain into the first domain, for transforming the audio input signal to acquire a transformed audio signal, being represented in the first domain.

Another embodiment may have a decoder for decoding an encoded audio signal, wherein the decoder comprises: a decoding unit for decoding the encoded audio signal to acquire an audio input signal being represented in a first domain, and an apparatus for audio signal transformation, comprising: a first conversion unit configured for converting an audio input signal from a first domain into an equivalent spatial domain, wherein the first domain is different from the equivalent spatial domain, a transformation unit configured for transforming the audio input signal, being represented in the equivalent spatial domain, depending on a transformation rule within the equivalent spatial domain to acquire a transformed audio signal, being represented in the equivalent spatial domain, and a second conversion unit for converting the transformed audio signal from the equivalent spatial domain into the first domain, for transforming the audio input signal to acquire a transformed audio signal, being represented in the first domain.

Another embodiment may have a method for audio signal transformation, comprising: determining, using spherical harmonics information, a transformation rule for transforming an audio input signal within a first domain, being different from a spherical harmonics domain, and transforming, using the transformation rule, the audio input signal, being represented in the first domain, to acquire a transformed audio signal being represented in the first domain, wherein the spherical harmonics information comprises information on a plurality of spherical harmonics and/or comprises information being represented in the spherical harmonics domain.

Another embodiment may have a method for audio signal transformation, comprising: converting an audio input signal from a first domain into a spherical harmonics domain, wherein the first domain is different from the spherical harmonics domain, transforming the audio input signal, being represented in the spherical harmonics domain, depending on a transformation rule within the spherical harmonics domain to acquire a transformed audio signal, being represented in the spherical harmonics domain, and converting the transformed audio signal from the spherical harmonics domain into the first domain.

Another embodiment may have a method for audio signal transformation, comprising: converting an audio input signal from a first domain into an equivalent spatial domain, wherein the first domain is different from the equivalent spatial domain, transforming the audio input signal, being represented in the equivalent spatial domain, depending on a transformation rule within the equivalent spatial domain to acquire a transformed audio signal, being represented in the equivalent spatial domain, and converting the transformed audio signal from the equivalent spatial domain into the first domain.

Another embodiment may have a non-transitory digital storage medium having a computer program stored thereon to perform the method for audio signal transformation, comprising: determining, using spherical harmonics information, a transformation rule for transforming an audio input signal within a first domain, being different from a spherical harmonics domain, and transforming, using the transformation rule, the audio input signal, being represented in the first domain, to acquire a transformed audio signal being represented in the first domain, wherein the spherical harmonics information comprises information on a plurality of spherical harmonics and/or comprises information being represented in the spherical harmonics domain, when said computer program is run by a computer.

Another embodiment may have a non-transitory digital storage medium having a computer program stored thereon to perform the method for audio signal transformation, comprising: converting an audio input signal from a first domain into a spherical harmonics domain, wherein the first domain is different from the spherical harmonics domain, transforming the audio input signal, being represented in the spherical harmonics domain, depending on a transformation rule within the spherical harmonics domain to acquire a transformed audio signal, being represented in the spherical harmonics domain, and converting the transformed audio signal from the spherical harmonics domain into the first domain, when said computer program is run by a computer.

Another embodiment may have a non-transitory digital storage medium having a computer program stored thereon to perform the method for audio signal transformation, comprising: converting an audio input signal from a first domain into an equivalent spatial domain, wherein the first domain is different from the equivalent spatial domain, transforming the audio input signal, being represented in the equivalent spatial domain, depending on a transformation rule within the equivalent spatial domain to acquire a transformed audio signal, being represented in the equivalent spatial domain, and converting the transformed audio signal from the equivalent spatial domain into the first domain, when said computer program is run by a computer.

An apparatus for audio signal transformation is provided. The apparatus comprises a determination unit configured for determining, using spherical harmonics information, a transformation rule for transforming an audio input signal within a first domain, being different from a spherical harmonics domain. Moreover, the apparatus comprises a transformation unit configured for transforming, using the transformation rule, the audio input signal, being represented in the first domain, to obtain a transformed audio signal being represented in the first domain. The spherical harmonics information comprises information on a plurality of spherical harmonics and/or comprises information being represented in the spherical harmonics domain.

Moreover, another apparatus for audio signal transformation is provided. The apparatus comprises a first conversion unit configured for converting an audio input signal from a first domain into a spherical harmonics domain, wherein the first domain is different from the spherical harmonics domain. Furthermore, the apparatus comprises a transformation unit configured for transforming the audio input signal, being represented in the spherical harmonics domain, depending on a transformation rule within the spherical harmonics domain to obtain a transformed audio signal, being represented in the spherical harmonics domain. Moreover, the apparatus comprises a second conversion unit for converting the transformed audio signal from the spherical harmonics domain into the first domain.

Furthermore, another apparatus for audio signal transformation is provided. The apparatus comprises a first conversion unit configured for converting an audio input signal from a first domain into an equivalent spatial domain, wherein the first domain is different from the equivalent spatial domain, Moreover, the apparatus comprises a transformation unit configured for transforming the audio input signal, being represented in the equivalent spatial domain, depending on a transformation rule within the equivalent spatial domain to obtain a transformed audio signal, being represented in the equivalent spatial domain. Furthermore, the apparatus comprises a second conversion unit for converting the transformed audio signal from the equivalent spatial domain into the first domain.

Furthermore, a method for audio signal transformation is provided. The method comprises:
Determining, using spherical harmonics information, a transformation rule for transforming an audio input signal within a first domain, being different from a spherical harmonics domain. And:
Transforming, using the transformation rule, the audio input signal, being represented in the first domain, to obtain a transformed audio signal being represented in the first domain.

The spherical harmonics information comprises information on a plurality of spherical harmonics and/or comprises information being represented in the spherical harmonics domain.

Moreover, another method for audio signal transformation is provided. The method comprises:
Converting an audio input signal from a first domain into a spherical harmonics domain, wherein the first domain is different from the spherical harmonics domain.
Transforming the audio input signal, being represented in the spherical harmonics domain, depending on a transformation rule within the spherical harmonics domain to obtain a transformed audio signal, being represented in the spherical harmonics domain. And:
Converting the transformed audio signal from the spherical harmonics domain into the first domain.

Furthermore, another method for audio signal transformation is provided. The method comprises:
Converting an audio input signal from a first domain into an equivalent spatial domain, wherein the first domain is different from the equivalent spatial domain.
Transforming the audio input signal, being represented in the equivalent spatial domain, depending on a transformation rule within the equivalent spatial domain to obtain a transformed audio signal, being represented in the equivalent spatial domain. And:
Converting the transformed audio signal from the equivalent spatial domain into the first domain.

Moreover, computer programs for implementing one of the above-described methods, when being executed on a computer or signal processor, are provided.

Some of the embodiments introduce and provide a signal processing workflow for audio signals in the equivalent spatial domain.

According to some embodiments, signal manipulation and/or transformation of audio signals in the equivalent spatial domain is provided.

In some embodiments, prevention of conversion of ESD signals to perform the signal manipulation and/or transformation is achieved.

Some of the embodiments provide an interpolation of transform matrices in the equivalent spatial domain.

### BRIEF DESCRIPTION OF THE DRAWINGS

Embodiments of the present invention will be detailed subsequently referring to the appended drawings, in which:

FIG. 1 illustrates an apparatus for audio signal transformation according to an embodiment.

FIG. 2 illustrates an approach, wherein an audio input is transformed from the equivalent spatial domain to the spherical harmonics domain, wherein a transformation matrix is determined and applied on the audio input in the spherical harmonics domain, and wherein the transformed audio input is transformed back to the equivalent spatial domain.

FIG. 3 illustrates an embodiment, wherein a transformation matrix is transformed from the spherical harmonics domain to the equivalent spatial domain, and wherein signal transformation is conducted in the equivalent spatial domain.

FIG. 4 illustrates an embodiment with matrix computation and signal processing in the equivalent spatial domain, wherein complexity and memory requirements are further reduced.

FIG. 5 illustrates Legendre polynomials up to the order n=5.

FIG. 6 illustrates spherical harmonics up to order n=4 and the corresponding modes.

FIG. 7 illustrates an apparatus for audio signal transformation according to a further embodiment.

FIG. 8 illustrates an apparatus for audio signal transformation according to another embodiment.

### DETAILED DESCRIPTION OF THE INVENTION

In the following particular embodiments of the present invention are provided.

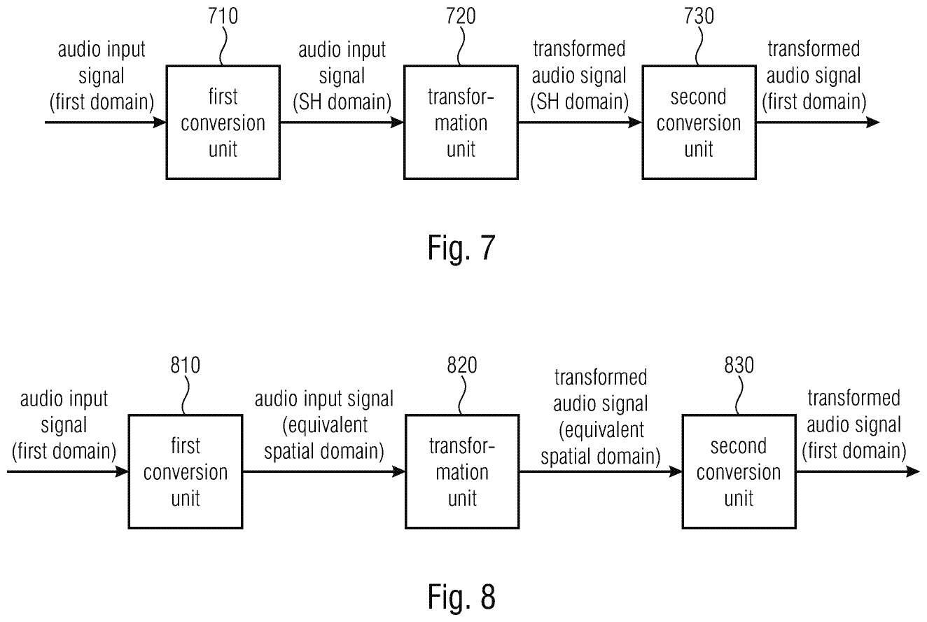

To solve the problem that transformations of audio signals within some particular domains have not been provided before, FIG. 7 provides an embodiment that solves the problem using the known signal transformation concepts in the spherical harmonics domain.

According to FIG. 7, an apparatus for audio signal transformation according to an embodiment is provided.

The apparatus comprises a first conversion unit 710 configured for converting an audio input signal from a first domain into a spherical harmonics domain, wherein the first domain is different from the spherical harmonics domain.

Moreover, the apparatus comprises a transformation unit 720 configured for transforming the audio input signal, being represented in the spherical harmonics domain, depending on a transformation rule within the spherical harmonics domain to obtain a transformed audio signal, being represented in the spherical harmonics domain.

Furthermore, the apparatus of FIG. 7 comprises a second conversion unit 730 for converting the transformed audio signal from the spherical harmonics domain into the first domain.

The spherical harmonics domain is, for example, particularly suitable for conducting transformations that, e.g., conduct spatial rotations of a soundfield.

According to an embodiment, the first domain may, e.g., be a spatial domain, which may, e.g., be different from the spherical harmonics domain. In a particular embodiment, the first domain may, e.g., be an equivalent spatial domain.

In an embodiment, the transformation rule may, e.g., comprise transformation information, wherein the transformation information comprises one or more transformation matrices and/or a plurality of transformation vectors and/or a plurality of coefficients for transforming the audio input signal, being represented in the first domain to obtain the transformed audio signal.

According to FIG. 8, an apparatus for audio signal transformation according to a further embodiment is provided.

The apparatus of FIG. 8 comprises a first conversion unit 810 configured for converting an audio input signal from a first domain into an equivalent spatial domain, wherein the first domain is different from the equivalent spatial domain,

Moreover, the apparatus comprises a transformation unit 820 configured for transforming the audio input signal, being represented in the equivalent spatial domain, depending on a transformation rule within the equivalent spatial domain to obtain a transformed audio signal, being represented in the equivalent spatial domain.

Furthermore, the apparatus of FIG. 8 comprises a second conversion unit 830 for converting the transformed audio signal from the equivalent spatial domain into the first domain.

The equivalent spatial domain is, for example, particularly suitable for conducting transformations that only relate to a specific spatial areas of a spatial environment. For example, if an interfering noise source that particularly affects a specific spatial area of the spatial environment, the equivalent spatial domain is particularly suitable for cancelling or at least attenuating such an interfering noise source in the specific spatial area.

According to an embodiment, the transformation rule may, e.g., be configured to implement a spatial rotation of the audio input signal. The transformation unit 720; 820 may, e.g., be configured to transform, using the transformation rule, the audio input signal by conducting the spatial rotation of the audio input signal.

In an embodiment, the apparatus may, e.g., be configured to receive a transformation input. The transformation unit 720; 820 may, e.g., be configured for transforming an audio input signal depending on the transformation input.

According to an embodiment, the transformation unit 720; 820 may, e.g., be configured to determine an interpolated transformation matrix by interpolating between the first transformation matrix and the further transformation matrix.

In an embodiment, the apparatus may, e.g., be configured to perform a binauralization processing to the transformed audio signal, being represented in the first domain, to obtain a binaural output.

To solve the problem that spatial transformations of audio signals in the equivalent spatial domain have not been described before, according an embodiment, an approach would be:

In a first step: Converting the ESD signals from the equivalent spatial domain into the spherical harmonics domain.

In a second step: Applying a transformation process (for example, a soundfield rotation). A particular (non-limiting) example would be a multiplication of a transformation matrix T_{SH} with the (audio) signal vector.

In a third step: Converting the transformed (audio) signal vector of the SH domain signal from the spherical harmonics domain back into the equivalent spatial domain.

A generalized embodiment for an arbitrary domain not restricted to the Equivalent

This embodiment has advantage that it achieves the desired object. However, the above embodiment has also disadvantages, because the conversion of the audio signals in the first step 1 and in the third step is costly. It would be more efficient to avoid the need to convert the audio signals from the equivalent spatial domain to the spherical harmonics domain and vice versa.

Other embodiments that are presented in the following avoid this disadvantage of the above embodiment.

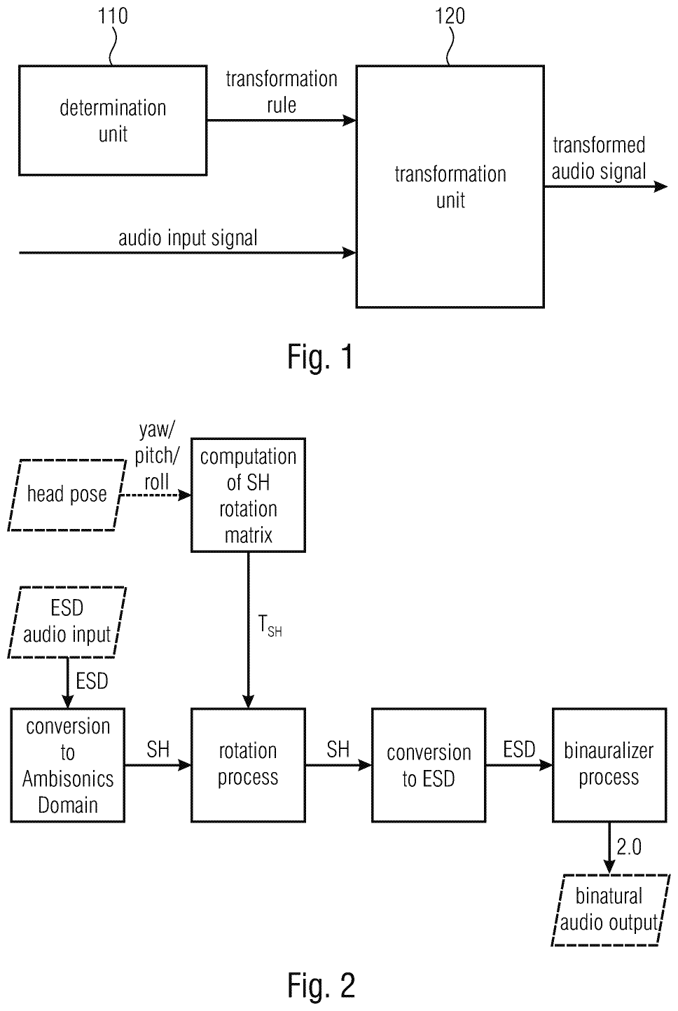

FIG. 1 illustrates an apparatus for audio signal transformation according to another embodiment that avoids the disadvantages of the embodiment of FIG. 7.

An apparatus for audio signal transformation is provided.

The apparatus of FIG. 1 comprises a determination unit 110 configured for determining, using spherical harmonics information, a transformation rule for transforming an audio input signal within a first domain, being different from a spherical harmonics domain.

Moreover, the apparatus of FIG. 1 comprises a transformation unit 120 configured for transforming, using the transformation rule, the audio input signal, being represented in the first domain, to obtain a transformed audio signal being represented in the first domain.

The spherical harmonics information comprises information on a plurality of spherical harmonics and/or comprises information being represented in the spherical harmonics domain.

According to an embodiment, the audio input signal and the transformed audio signal may, e.g., be represented in the first domain, being a spatial domain, which may, e.g., be different from the spherical harmonics domain. In a particular embodiment, the first domain may, e.g., be an equivalent spatial domain.

In an embodiment, the transformation rule may, e.g., comprise transformation information, wherein the transformation information comprises one or more transformation matrices and/or a plurality of transformation vectors and/or a plurality of coefficients for transforming the audio input signal, being represented in the first domain to obtain the transformed audio signal, being represented in the first domain. The transformation information depends on the plurality of spherical harmonics.

According to an embodiment, the transformation information depends on transformation information for transforming audio content in the spherical harmonics domain.

In an embodiment, the transformation information for transforming audio content in the spherical harmonics domain comprises one or more transformation matrices and/or a plurality of transformation vectors and/or a plurality of coefficients for transforming the audio content in the spherical harmonics domain.

According to an embodiment, the determination unit 110 may, e.g., be configured to determine the transformation rule such that the transformation rule may, e.g., be configured to implement a spatial rotation of the audio input signal within the first domain. The transformation unit 120 may, e.g., be configured to transform, using the transformation rule, the audio input signal, being represented in the first domain, by conducting the spatial rotation of the audio input signal in the first domain to obtain the transformed audio signal being represented in the first domain.

In an embodiment, the determination unit 110 may, e.g., be configured to determine the transformation rule by determining a rotation matrix or a plurality of rotation vectors or a plurality of coefficients of the rotation matrix within the spherical harmonics domain, and by converting the rotation matrix of the plurality of rotation vectors or the plurality of coefficients of the rotation matrix from the spherical harmonics domain into the first domain.

According to an embodiment, the determination unit 110 may, e.g., be configured to determine the transformation rule by determining a rotation matrix or a plurality of rotation vectors or a plurality of coefficients of the rotation matrix directly within the first domain without converting rotation information from the spherical harmonics domain into the first domain.

In an embodiment, the rotation matrix or the plurality of rotation vectors or the plurality of coefficients may, e.g., define a rotation along one or more rotation axes.

In an embodiment, the determination unit 110 may, e.g., be configured to transform the plurality of spatial directions to obtain a plurality of transformed directions of the first domain. The determination unit 110 may, e.g., be configured to determine the transformation rule such that the transformation rule depends on information on the plurality of spherical harmonics for the plurality of transformed directions.

According to an embodiment, the determination unit 110 may, e.g., be configured to determine the transformation rule depending on a transformation matrix T_{ESD} being defined as:

T_{ESD}=Y⁻¹(θ)·Y(M(θ)),

wherein θ indicates a plurality of directions of the first domain, wherein Y⁻¹(θ) indicates an inverse of Y(θ), with Y(θ) indicating the plurality of spherical harmonics for the plurality of directions θ of the first domain, and wherein M(θ) indicates a modification of a soundfield.

For example, in an embodiment, modification matrix M(θ) may, e.g., be defined as

M(θ)=R(Φ,θ,ψ)·θ,

wherein θ indicates a plurality of directions of the first domain, and wherein R(Φ, θ, ψ) indicates a rotation with a rotation angle (Φ, θ, ψ), wherein Φ indicates yaw, wherein θ indicates pitch, and wherein ψ indicates roll, wherein at least one of Φ, θ, ψ is different from 0°, and wherein any other one of Φ, θ, ψ is also different from 0° or is equal to 0°. In other words, a rotation is conducted along one or more rotation axes.

In another embodiment, the determination unit 110 may, e.g., be configured to determine the transformation rule depending on a transformation matrix T_{ESD} being defined as:

T_{ESD}=Y⁻¹(θ)·Y(M(θ))·Y⁻¹(η)·Y(θ)

wherein θ indicates a first plurality of directions of the first domain, wherein Y(θ) indicates the plurality of spherical harmonics for the first plurality of directions θ of the first domain, wherein Y⁻¹(θ) indicates an inverse of Y(θ), wherein M(η) indicates a modification of a soundfield, wherein η indicates a second plurality of directions, and wherein Y⁻¹(η) indicates an inverse of Y(η), with Y(η) indicating the plurality of spherical harmonics for the second plurality of directions η.

For example, in an embodiment, modification matrix M(η) may, e.g., be defined as

M(η)=R(Φ,θ,ψ)·η,

wherein R(Φ, θ, ψ) indicates a rotation with a rotation angle (Φ, θ, ψ), wherein Φ indicates yaw, wherein θ indicates pitch, and wherein ψ indicates roll, and wherein η indicates one or more directions which are to be rotated by the rotation R(Φ, θ, ψ), wherein at least one of Φ, θ, ψ is different from 0°, and wherein any other one of Φ, θ, ψ is also different from 0° or is equal to 0°. In other words, a rotation is conducted along one or more rotation axes.

According to an embodiment, the apparatus may, e.g., be configured to receive a transformation input. The determination unit 110 may, e.g., be configured to determine the transformation rule for transforming an audio input signal within the first domain depending on the transformation input.

In an embodiment, the transformation rule comprises a first transformation matrix. The determination unit 110 may, e.g., be configured to determine a further transformation rule comprising a further transformation matrix. The determination unit 110 may, e.g., be configured to determine an interpolated transformation matrix by interpolating between the first transformation matrix and the further transformation matrix.

According to an embodiment, the apparatus may, e.g., be configured to perform a binauralization processing to the transformed audio signal, being represented in the first domain, to obtain a binaural output.

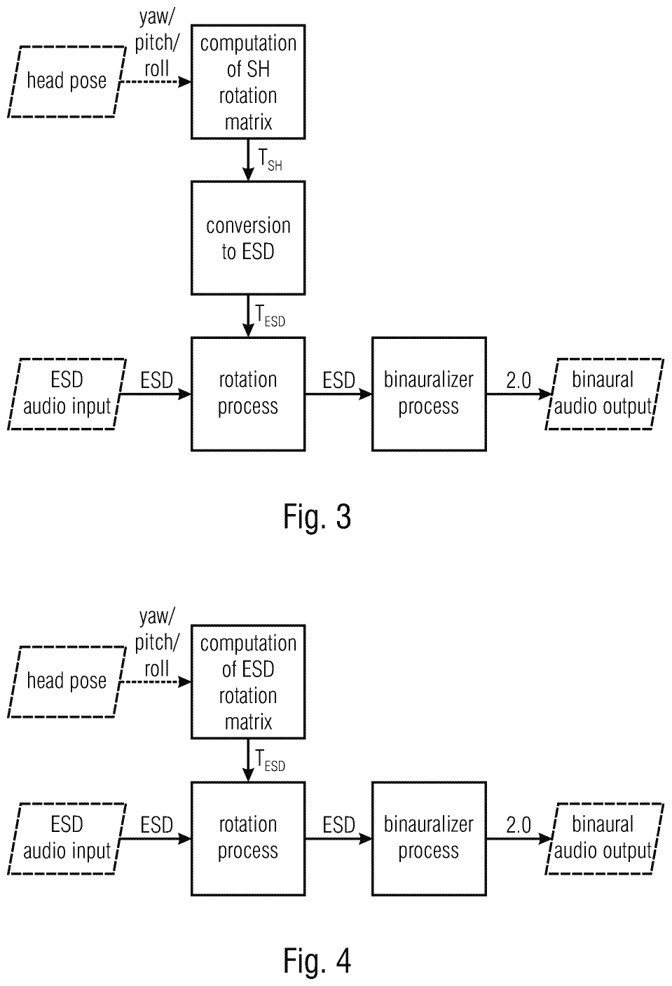

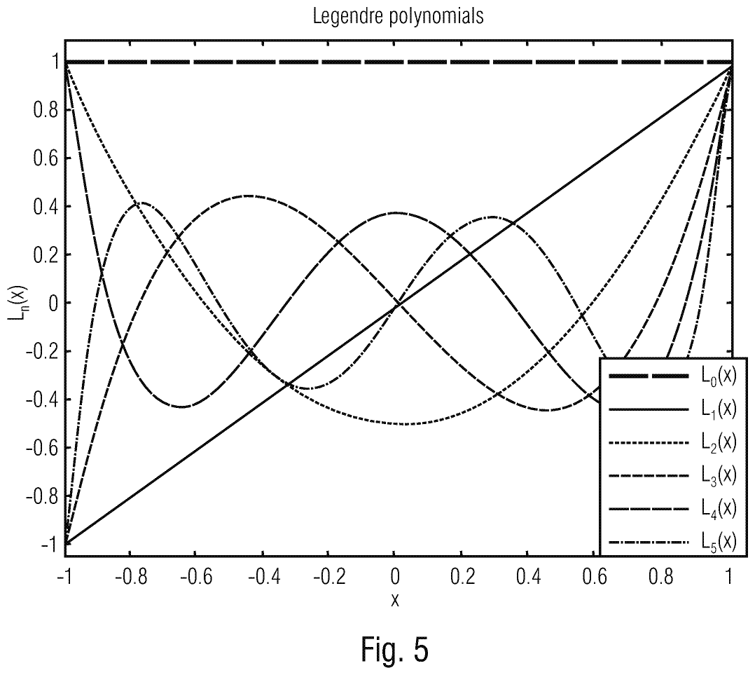

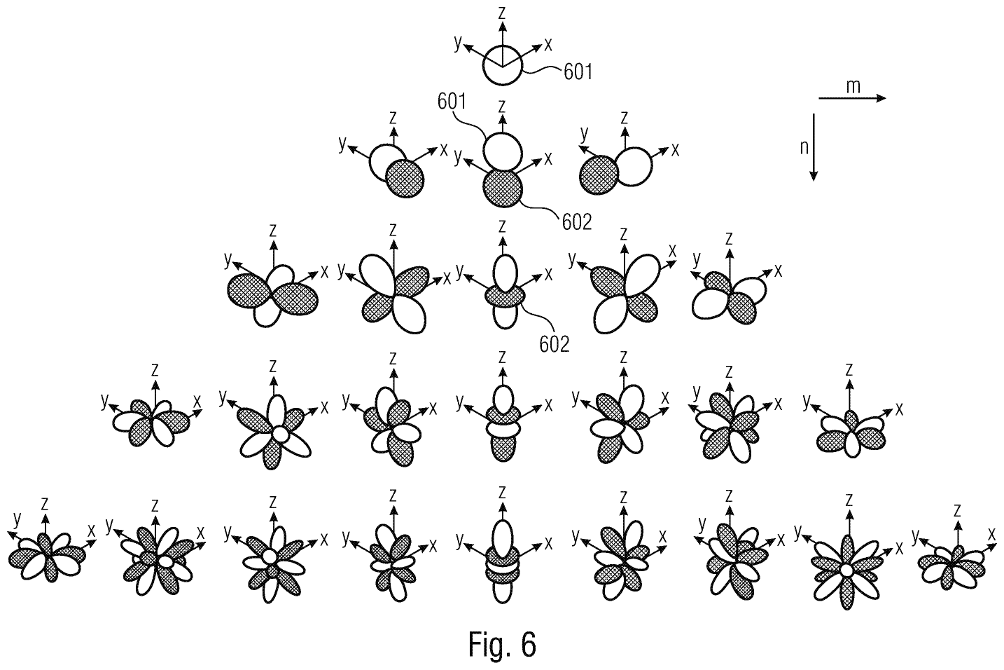

FIG. 3 illustrates an embodiment, wherein a transformation matrix is transformed from the SH Domain to the equivalent spatial domain, and wherein signal transformation is conducted in the equivalent spatial domain.

In particular, FIG. 3 depicts an improved signal flow. Here, the conversion of the audio signals is avoided by performing the soundfield transformation process in the equivalent spatial domain.

In a specific embodiment of FIG. 3, in a first step, a conversion of the transformation matrix from the SH domain to the equivalent spatial domain is conducted.

In a further step, the signal transformation is performed in the equivalent spatial domain, including but not limited to a multiplication of a transformation matrix with the ESD signal vector. For example, a soundfield rotation may, e.g., be performed.

An advantage of such an embodiment is that the conversion of the transformation matrix is only needed whenever a new transformation matrix is being computed, e.g., once per audio frame.

Regarding matrix computation, generally speaking, a transformation matrix T_{SH} in the spherical harmonics domain may, e.g., be converted into the equivalent spatial domain via:

T_{ESD}=Y⁻¹(θ)·T_{SH}·Y(θ), (1)

where θ represents the (N+1)² directions used to describe the ESD signal and Y(θ) represents the spherical harmonics up to order N for those (N+1)² directions.

T_{ESD} indicates the transformation matrix in the equivalent spatial domain. T_{ESD} represents a transformation rule in the equivalent spatial domain.

In some embodiments, the transformation matrix T_{ESD} may, e.g., be a constant matrix or may, e.g., be at least independent from time t. In other embodiments, the transformation matrix T_{ESD} may, e.g., be time-variant/may, e.g., depend on time t: T_{ESD}=T_{ESD} (t) The notation T_{ESD} shall refer to all these embodiments, i.e., to embodiments, where T_{ESD} is static or where T_{ESD} does at least not depend on time t, and also to cases, where T_{ESD} depends on time, i.e., where T_{ESD}=T_{ESD}(t).

The same applies to the transformation matrix T_{SH}: In some embodiments, the transformation matrix T_{SH} may, e.g., be a constant matrix or may, e.g., be at least independent from time t. In other embodiments, the transformation matrix T_{SH} may, e.g., be time-variant/may, e.g., depend on time t: T_{SH}=T_{SH}(t). The notation T_{SH} shall refer to all these embodiments, i.e., to embodiments, where T_{SH} is static or where T_{SH} does at least not depend on time t, and also to cases, where T_{SH} depends on time, i.e., where T_{SH}=T_{SH}(t).

Y(θ) and Y⁻¹(θ) represents spherical harmonics information indicating information on a plurality of spherical harmonics. T_{SH} represents spherical harmonics information indicating information being represented in the spherical harmonics domain.

For a soundfield rotation, the transformation matrix T_{SH} may be computed as

T_{SH}=Y(\tilde{η})·Y⁻¹(η), (2)

where η represents L≥(N+1)² spatial directions and Y(η) represents the spherical harmonics up to order N for those L directions. The directions \tilde{η} can be computed based on the desired rotation angles via:

\tilde{η}=R(Φ,θ,ψ)·η, (3)

with

$$R ( Φ , θ , ψ ) = ( \begin{matrix}1 & 0 & 0 \\ 0 & cos Φ & - sin Φ \\ 0 & sin Φ & cos Φ\end{matrix} ) \cdot ( \begin{matrix}cos θ & 0 & sin θ \\ 0 & 1 & 0 \\ - sin Φ & 0 & cos Φ\end{matrix} ) \cdot ( \begin{matrix}cos ψ & - sin ψ & 0 \\ sin ψ & cos ψ & 0 \\ 0 & 0 & 1\end{matrix} ) , \qquad ( 4 )$$

with (Φ, θ, ψ) being the rotation angle around the x-axis (Φ, roll), y-axis (θ, pitch) and z-axis (ψ, yaw).

Combining equation 1, 2 and 3 yields

T_{ESD}=Y⁻¹(θ)·Y(R(Φ,θ,ψ)·η)·Y⁻¹(η)·Y(θ), (5)

In equations (2), (3) and (5), n indicates the plurality of spatial directions. \tilde{η} indicates a plurality of transformed directions. Rotation angle (Φ, θ, ψ) indicates (for example, received) transformation input. And Y(\tilde{η})=Y(R(Φ, θ, ψ)·η) indicates information on the plurality of spherical harmonics for the plurality of transformed directions.

From equation (5), it follows that the soundfield transformation can be done as:

\tilde{S}_{ESD}(t)=T_{ESD}S_{ESD}(t), (6)

If T_{ESD} depends on time t, i.e., if T_{ESD}=T_{ESD} (t), equation (6) may also be expressed as:

\tilde{S}_{ESD}(t)=T_{ESD}(t)S_{ESD}(t), (6a)

In an embodiment, equation (5) is used to determine the transformation matrix in the equivalent spatial domain.

In another embodiment, equation (1) is used to determine the transformation matrix in the equivalent spatial domain. In such an embodiment, at first, the transformation matrix in the spherical harmonics domain is determined which is then converted into the equivalent spatial domain according to equation (1).

The embodiment which uses equation (5), does not require to determine a transformation matrix in the spherical harmonics domain. Instead, in such an embodiment, the transformation matrix in the equivalent spatial domain is directly computed according to equation (5) using

Y(θ) which represents, as outlined above, spherical harmonics information indicating information on a plurality of spherical harmonics.

As outlined above, the transformation matrix in the equivalent spatial domain represents a transformation rule for transforming an audio input signal within the equivalent spatial domain.

However, it is apparent that instead of determining a transformation matrix, it is equally apparent to determine a plurality of transformation vectors, which comprise the information of the transformation matrix T_{ESD} based on the above-described principles. Such a plurality of transformation vectors also constitute transformation information of a transformation rule for transforming an audio input signal within the equivalent spatial domain.

Moreover, it is equally apparent that instead of determining a transformation matrix or a plurality of transformation vectors, it is likewise apparent to only determine a plurality of coefficients that comprise the information of the plurality of matrix coefficients of the transformation matrix T_{ESD}. Such coefficients also constitute transformation information of a transformation rule for transforming an audio input signal within the equivalent spatial domain.

Moreover, it is also apparent that the provided embodiments are not limited to the equivalent spatial domain but that the provided embodiments are equally applicable to any other (spatial) domain, in particular, a spatial domain, in which the audio signal is represented by a plurality of spatial audio signal components (for example, by three or more spatial audio signal components).

Returning to equation (5), the following further embodiments are based on the finding that the computational complexity and memory requirements may, e.g., be further reduced, if the transformation matrix is directly computed in the equivalent spatial domain, rather than in the spherical harmonics domain.

FIG. 4 illustrates such an embodiment with a respective signal flow, wherein matrix computation and signal processing in the equivalent spatial domain is conducted, and wherein complexity and memory requirements are reduced compared to the embodiment of FIG. 3.

Regarding computation of the ESD rotation matrix, the rotation transformation matrix T_{ESD} for an ESD signal may, e.g., be directly computed. When the directions η are equal to the spatial directions θ, which define the equivalent spatial domain, equation (5) can be expressed as:

T_{ESD}=Y⁻¹(θ)·Y(R(Φ,θ,ψ)·θ)·Y⁻¹(θ)·Y(θ), (7)

As already outlined above, Y⁻¹(θ) and Y(θ) represents spherical harmonics information indicating information on a plurality of spherical harmonics.

Considering equation (7), the term Y⁻¹(θ)·Y(θ) (approximately) yields an identity matrix.

Thus, the computation of T_{ESD} can be simplified to:

T_{ESD}=Y⁻¹(θ)·Y(R(Φ,θ,ψ)·θ), (8)

\tilde{S}_{ESD}(t)=T_{ESD}S_{ESD}(t), (9)

Again, if T_{ESD} depends on time t, i.e., if T_{ESD}=T_{ESD}(t), equation (9) may also be expressed as:

\tilde{S}_{ESD}(t)=T_{ESD}(t)S_{ESD}(t), (9a)

It is worth noting that the term Y⁻¹(θ) is independent from the desired rotation. Thus, in some embodiments, Y⁻¹(θ) may, e.g., be precomputed and thus does not contribute to runtime complexity.

According to some embodiments, interpolation of transformation matrices is conducted.

In such embodiments, an interpolation of transformation matrices from one state to another may be desired to avoid audible artifacts. To limit computational complexity overhead, for example, the efficient linear interpolation method may, e.g., usually applied, for example, depending on

T=αT₁+(1−α)T₂, (10)

with α being the interpolation value, with T₁ being a first transformation matrix and with T₂ being a further transformation matrix. For example, T₁ may, e.g., be defined as T₁=Tₜ₀, and T₂ may, e.g., be defined as T₂=Tₜ₁, wherein Tₜ₀ indicates a transformation matrix at time t0 and wherein Tₜ₁ indicates a transformation matrix at time t1.

In some other embodiments, an energy compensated interpolation scheme may, e.g., be employed.

The above-described embodiments may, for example, be employed in an audio decoder/renderer (for example, a future MPEG-I decoder/renderer), in which spatial (for example, ESD) audio signals may, e.g., be rotated in real-time to perform time-variant binauralization. For an efficient real-time implementation it is desired to prevent domain switching of ESD signals.

For example, in an embodiment, a decoder for decoding an encoded audio signal is provided.

The decoder may, e.g., comprise a decoding unit for decoding the encoded audio signal to obtain an audio input signal being represented in a first domain.

Moreover, the decoder may, e.g., comprise an apparatus as described according to one of the embodiments described above for transforming the audio input signal to obtain a transformed audio signal, being represented in the first domain.

In the following, further embodiments of the invention are provided.

According to some embodiments, an apparatus, a method or a computer program for generating an output representation from an input representation as described before is provided.

In other embodiments, an apparatus, a method or a computer program for generating an output audio representation from an input audio representation is provided, which comprises:
Generation of a rotation information using input data.
Converting the rotation information into a domain, in which the input audio representation is given to obtain a converted rotation information. And:
Applying the converted rotation information to the input audio representation to obtain the audio output representation.

In some embodiments, the apparatus, the method or the computer program may, e.g., further comprise performing a binauralization processing to the output audio representation to obtain a binaural output.

According to some embodiments, an apparatus, a method or a computer program for generating an output audio representation from an input audio representation is provided, which comprises:
Generation of a rotation information using input data in a domain, in which the input audio representation is given. And:
Applying the rotation information to the input audio representation to obtain the audio output representation.

In some embodiments, the apparatus, the method or the computer program may, e.g., further comprise performing a binauralization processing to the output audio representation to obtain a binaural output.

According to some embodiments, an apparatus, a method or a computer program for generating an output audio representation from an input audio representation is provided, which comprises:
Converting the input audio representation into an intermediate domain representation.
Generation of a rotation information using input data.
Applying the converted rotation information to the intermediate domain representation to obtain a processed intermediate domain representation. And:
Converting the intermediate domain representation into the output audio representation.

In some embodiments, the apparatus, the method or the computer program may, e.g., further comprise performing a binauralization processing to the output audio representation to obtain a binaural output.

It is to be mentioned here that all alternatives or aspects as discussed before and all aspects as defined by independent claims in the following claims can be used individually, i.e., without any other alternative or object than the contemplated alternative, object or independent claim. However, in other embodiments, two or more of the alternatives or the aspects or the independent claims can be combined with each other and, in other embodiments, all aspects, or alternatives and all independent claims can be combined to each other.

An inventively encoded or processed signal can be stored on a digital storage medium or a non-transitory storage medium or can be transmitted on a transmission medium such as a wireless transmission medium or a wired transmission medium such as the Internet.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier or a non-transitory storage medium.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An apparatus for audio signal transformation, comprising:
a determination unit configured for determining, using spherical harmonics information, a transformation rule for transforming an audio input signal within a first domain, being different from a spherical harmonics domain, and
a transformation unit configured for transforming, using the transformation rule, the audio input signal, being represented in the first domain, to acquire a transformed audio signal being represented in the first domain,
wherein the spherical harmonics information comprises information on a plurality of spherical harmonics and/or comprises information being represented in the spherical harmonics domain.

2. An apparatus according to claim 1,
wherein the audio input signal and the transformed audio signal are represented in the first domain, being a spatial domain, which is different from the spherical harmonics domain.

3. An apparatus according to claim 1,
wherein the first domain is an equivalent spatial domain.

4. An apparatus according to claim 1,
wherein the transformation rule comprises transformation information, wherein the transformation information comprises one or more transformation matrices and/or a plurality of transformation vectors and/or a plurality of coefficients for transforming the audio input signal, being represented in the first domain to acquire the transformed audio signal, being represented in the first domain,
wherein the transformation information depends on the plurality of spherical harmonics.

5. An apparatus according to claim 4,
wherein the transformation information depends on transformation information for transforming audio content in the spherical harmonics domain.

6. An apparatus according to claim 5,
wherein the transformation information for transforming audio content in the spherical harmonics domain comprises one or more transformation matrices and/or a plurality of transformation vectors and/or a plurality of coefficients for transforming the audio content in the spherical harmonics domain.

7. An apparatus according to claim 1,
wherein the determination unit is configured to determine the transformation rule such that the transformation rule is configured to implement a spatial rotation of the audio input signal within the first domain, and
wherein the transformation unit is configured to transform, using the transformation rule, the audio input signal, being represented in the first domain, by conducting the spatial rotation of the audio input signal in the first domain to acquire the transformed audio signal being represented in the first domain.

8. An apparatus according to claim 7,
wherein the determination unit is configured to determine the transformation rule by determining a rotation matrix or a plurality of rotation vectors or a plurality of coefficients of the rotation matrix within the spherical harmonics domain, and by converting the rotation matrix of the plurality of rotation vectors or the plurality of coefficients of the rotation matrix from the spherical harmonics domain into the first domain.

9. An apparatus according to claim 7,
wherein the determination unit is configured to determine the transformation rule by determining a rotation matrix or a plurality of rotation vectors or a plurality of coefficients of the rotation matrix directly within the first domain without converting rotation information from the spherical harmonics domain into the first domain.

10. An apparatus according to claim 1,
wherein the determination unit is configured to transform the plurality of spatial directions to acquire a plurality of transformed directions of the first domain, and
wherein the determination unit is configured to determine the transformation rule such that the transformation rule depends on information on the plurality of spherical harmonics for the plurality of transformed directions.

11. An apparatus according to claim 10,
wherein the determination unit is configured to determine the transformation rule such that the transformation rule implements a rotation and depends on the information Y(\tilde{η}) on the plurality of spherical harmonics for the plurality of transformed directions being defined as:
Y(\tilde{η})=Y(R(Φ,θ,ψ)·η)
wherein η indicates the plurality of spatial directions,
wherein \tilde{η} indicates the plurality of transformed directions,
wherein R(Φ, θ, ψ) indicates a rotation with a rotation angle (Φ, θ, ψ), wherein Φ indicates yaw, wherein θ indicates pitch, and wherein ψ indicates roll, wherein at least one of Φ, θ, ψ is different from 0°, and wherein any other one of Φ, θ, ψ is also different from 0° or is equal to 0°.

12. An apparatus according to claim 1,
wherein the determination unit is configured to determine the transformation rule depending on a transformation matrix T_{ESD} being defined as:
T_{ESD}=Y⁻¹(θ)·T_{SH}·Y(θ),
wherein T_{SH} indicates a transformation matrix in the spherical harmonics domain,
wherein θ indicates a plurality of directions of the first domain,
wherein Y(θ) indicates the plurality of spherical harmonics for the plurality of directions θ of the first domain, and
wherein Y⁻¹(θ) indicates an inverse of Y(θ).

13. An apparatus according to claim 1,
wherein the determination unit is configured to determine the transformation rule depending on a transformation matrix T_{ESD} being defined as:
T_{ESD}=Y⁻¹(θ)·Y(M(θ)),
wherein θ indicates a plurality of directions of the first domain,
wherein Y⁻¹(θ) indicates an inverse of Y(θ), with Y(θ) indicating the plurality of spherical harmonics for the plurality of directions θ of the first domain, and
wherein M(θ) indicates a modification of a soundfield.

14. An apparatus according to claim 1,
wherein the determination unit is configured to determine the transformation rule depending on a transformation matrix T_{ESD} being defined as:
T_{ESD}=Y⁻¹(θ)·Y(R(Φ,θ,ψ)·θ),
wherein θ indicates a plurality of directions of the first domain,
wherein Y⁻¹(θ) indicates an inverse of Y(θ), with Y(θ) indicating the plurality of spherical harmonics for the plurality of directions θ of the first domain, and
wherein R(Φ, θ, ψ) indicates a rotation with a rotation angle (Φ, θ, ψ), wherein Φ indicates yaw, wherein θ indicates pitch, and wherein ψ indicates roll, wherein at least one of Φ, θ, ψ is different from 0°, and wherein any other one of Φ, θ, ψ is also different from 0° or is equal to 0°.

15. An apparatus according to claim 1,
wherein the determination unit is configured to determine the transformation rule depending on a transformation matrix T_{ESD} being defined as:
T_{ESD}=Y⁻¹(θ)·Y(M(η))·Y⁻¹(η)·Y(θ)
wherein θ indicates a first plurality of directions of the first domain,
wherein Y(θ) indicates the plurality of spherical harmonics for the first plurality of directions θ of the first domain,
wherein Y⁻¹(θ) indicates an inverse of Y(θ),
wherein M(η) indicates a modification of a soundfield,
wherein η indicates a second plurality of directions, and
wherein Y⁻¹(η) indicates an inverse of Y(η), with Y(η) indicating the plurality of spherical harmonics for the second plurality of directions η.

16. An apparatus according to claim 1,
wherein the determination unit is configured to determine the transformation rule depending on a transformation matrix T_{ESD} being defined as:
T_{ESD}=Y⁻¹(θ)·Y(R(Φ,θ,ψ)·η)·Y⁻¹(η)·Y(θ)
wherein θ indicates a plurality of directions of the first domain,
wherein Y(θ) indicates the plurality of spherical harmonics for the plurality of directions θ of the first domain,
wherein Y⁻¹(θ) indicates an inverse of Y(θ),
wherein R(Φ, θ, ψ) indicates a rotation with a rotation angle (Φ, θ, ψ) wherein Φ indicates yaw, wherein θ indicates pitch, and wherein ψ indicates roll, wherein at least one of Φ, θ, ψ is different from 0°, and wherein any other one of Φ, θ, ψ is also different from 0° or is equal to 0°,
wherein η indicates a plurality of directions which are to be rotated by the rotation R(Φ, θ, ψ), and
wherein Y⁻¹(η) indicates an inverse of Y(η), with Y(η) indicating the plurality of spherical harmonics for the plurality of directions η.

17. An apparatus according to claim 1,
wherein the apparatus is configured to receive a transformation input,
wherein the determination unit is configured to determine the transformation rule for transforming an audio input signal within the first domain depending on the transformation input.

18. An apparatus according to claim 1,
wherein the transformation rule comprises a first transformation matrix,
wherein the determination unit is configured to determine a further transformation rule comprising a further transformation matrix, and
wherein the determination unit is configured to determine an interpolated transformation matrix by interpolating between the first transformation matrix and the further transformation matrix.

19. An apparatus according to claim 1,
wherein the apparatus is configured to perform a binauralization processing to the transformed audio signal, being represented in the first domain, to acquire a binaural output.

20. An apparatus for audio signal transformation, comprising:
a first conversion unit configured for converting an audio input signal from a first domain into a spherical harmonics domain, wherein the first domain is different from the spherical harmonics domain,
a transformation unit configured for transforming the audio input signal, being represented in the spherical harmonics domain, depending on a transformation rule within the spherical harmonics domain to acquire a transformed audio signal, being represented in the spherical harmonics domain, and
a second conversion unit for converting the transformed audio signal from the spherical harmonics domain into the first domain.

21. An apparatus according to claim 20,
wherein the first domain is a spatial domain, which is different from the spherical harmonics domain.

22. An apparatus according to claim 20,
wherein the first domain is an equivalent spatial domain.

23. An apparatus for audio signal transformation, comprising:
a first conversion unit configured for converting an audio input signal from a first domain into an equivalent spatial domain, wherein the first domain is different from the equivalent spatial domain,
a transformation unit configured for transforming the audio input signal, being represented in the equivalent spatial domain, depending on a transformation rule within the equivalent spatial domain to acquire a transformed audio signal, being represented in the equivalent spatial domain, and
a second conversion unit for converting the transformed audio signal from the equivalent spatial domain into the first domain.

24. An apparatus according to claim 20,
wherein the transformation rule comprises transformation information, wherein the transformation information comprises one or more transformation matrices and/or a plurality of transformation vectors and/or a plurality of coefficients for transforming the audio input signal, being represented in the first domain to acquire the transformed audio signal.

25. An apparatus according to claim 23,
wherein the transformation rule comprises transformation information, wherein the transformation information comprises one or more transformation matrices and/or a plurality of transformation vectors and/or a plurality of coefficients for transforming the audio input signal, being represented in the first domain to acquire the transformed audio signal.

26. An apparatus according to claim 20,
wherein the transformation rule is configured to implement a spatial rotation of the audio input signal, and
wherein the transformation unit is configured to transform, using the transformation rule, the audio input signal by conducting the spatial rotation of the audio input signal.

27. An apparatus according to claim 23,
wherein the transformation rule is configured to implement a spatial rotation of the audio input signal, and
wherein the transformation unit is configured to transform, using the transformation rule, the audio input signal by conducting the spatial rotation of the audio input signal.

28. An apparatus according to claim 20,
wherein the apparatus is configured to receive a transformation input,
wherein the transformation unit is configured for transforming an audio input signal depending on the transformation input.

29. An apparatus according to claim 23,
wherein the apparatus is configured to receive a transformation input,
wherein the transformation unit is configured for transforming an audio input signal depending on the transformation input.

30. An apparatus according to claim 20,
wherein the transformation unit is configured to determine an interpolated transformation matrix by interpolating between the first transformation matrix and the further transformation matrix.

31. An apparatus according to claim 23,
wherein the transformation unit is configured to determine an interpolated transformation matrix by interpolating between the first transformation matrix and the further transformation matrix.

32. An apparatus according to claim 20,
wherein the apparatus is configured to perform a binauralization processing to the transformed audio signal, being represented in the first domain, to acquire a binaural output.

33. An apparatus according to claim 23,
wherein the apparatus is configured to perform a binauralization processing to the transformed audio signal, being represented in the first domain, to acquire a binaural output.

34. Decoder for decoding an encoded audio signal, wherein the decoder comprises:
a decoding unit for decoding the encoded audio signal to acquire an audio input signal being represented in a first domain, and
an apparatus for audio signal transformation, comprising:
a determination unit configured for determining, using spherical harmonics information, a transformation rule for transforming an audio input signal within a first domain, being different from a spherical harmonics domain, and
a transformation unit configured for transforming, using the transformation rule, the audio input signal, being represented in the first domain, to acquire a transformed audio signal being represented in the first domain,
wherein the spherical harmonics information comprises information on a plurality of spherical harmonics and/or comprises information being represented in the spherical harmonics domain, for transforming the audio input signal to acquire a transformed audio signal, being represented in the first domain.

35. Decoder for decoding an encoded audio signal, wherein the decoder comprises:
a decoding unit for decoding the encoded audio signal to acquire an audio input signal being represented in a first domain, and
an apparatus for audio signal transformation, comprising:
a first conversion unit configured for converting an audio input signal from a first domain into a spherical harmonics domain, wherein the first domain is different from the spherical harmonics domain,
a transformation unit configured for transforming the audio input signal, being represented in the spherical harmonics domain, depending on a transformation rule within the spherical harmonics domain to acquire a transformed audio signal, being represented in the spherical harmonics domain, and
a second conversion unit for converting the transformed audio signal from the spherical harmonics domain into the first domain, for transforming the audio input signal to acquire a transformed audio signal, being represented in the first domain.

36. Decoder for decoding an encoded audio signal, wherein the decoder comprises:
a decoding unit for decoding the encoded audio signal to acquire an audio input signal being represented in a first domain, and
an apparatus for audio signal transformation, comprising:
a first conversion unit configured for converting an audio input signal from a first domain into an equivalent spatial domain, wherein the first domain is different from the equivalent spatial domain,
a transformation unit configured for transforming the audio input signal, being represented in the equivalent spatial domain, depending on a transformation rule within the equivalent spatial domain to acquire a transformed audio signal, being represented in the equivalent spatial domain, and
a second conversion unit for converting the transformed audio signal from the equivalent spatial domain into the first domain, for transforming the audio input signal to acquire a transformed audio signal, being represented in the first domain.

37. A method for audio signal transformation, comprising:
determining, using spherical harmonics information, a transformation rule for transforming an audio input signal within a first domain, being different from a spherical harmonics domain, and
transforming, using the transformation rule, the audio input signal, being represented in the first domain, to acquire a transformed audio signal being represented in the first domain,
wherein the spherical harmonics information comprises information on a plurality of spherical harmonics and/or comprises information being represented in the spherical harmonics domain.

38. A method for audio signal transformation, comprising:
converting an audio input signal from a first domain into a spherical harmonics domain, wherein the first domain is different from the spherical harmonics domain,
transforming the audio input signal, being represented in the spherical harmonics domain, depending on a transformation rule within the spherical harmonics domain to acquire a transformed audio signal, being represented in the spherical harmonics domain, and
converting the transformed audio signal from the spherical harmonics domain into the first domain.

39. A method for audio signal transformation, comprising:
converting an audio input signal from a first domain into an equivalent spatial domain, wherein the first domain is different from the equivalent spatial domain,
transforming the audio input signal, being represented in the equivalent spatial domain, depending on a transformation rule within the equivalent spatial domain to acquire a transformed audio signal, being represented in the equivalent spatial domain, and
converting the transformed audio signal from the equivalent spatial domain into the first domain.

40. A non-transitory digital storage medium having a computer program stored thereon to perform the method for audio signal transformation, comprising:
determining, using spherical harmonics information, a transformation rule for transforming an audio input signal within a first domain, being different from a spherical harmonics domain, and
transforming, using the transformation rule, the audio input signal, being represented in the first domain, to acquire a transformed audio signal being represented in the first domain,
wherein the spherical harmonics information comprises information on a plurality of spherical harmonics and/or comprises information being represented in the spherical harmonics domain, when said computer program is run by a computer.

41. A non-transitory digital storage medium having a computer program stored thereon to perform the method for audio signal transformation, comprising:
converting an audio input signal from a first domain into a spherical harmonics domain, wherein the first domain is different from the spherical harmonics domain,
transforming the audio input signal, being represented in the spherical harmonics domain, depending on a transformation rule within the spherical harmonics domain to acquire a transformed audio signal, being represented in the spherical harmonics domain, and
converting the transformed audio signal from the spherical harmonics domain into the first domain, when said computer program is run by a computer.

42. A non-transitory digital storage medium having a computer program stored thereon to perform the method for audio signal transformation, comprising:
converting an audio input signal from a first domain into an equivalent spatial domain, wherein the first domain is different from the equivalent spatial domain,
transforming the audio input signal, being represented in the equivalent spatial domain, depending on a transformation rule within the equivalent spatial domain to acquire a transformed audio signal, being represented in the equivalent spatial domain, and
converting the transformed audio signal from the equivalent spatial domain into the first domain, when said computer program is run by a computer.
